(19) United States
(12) Patent Application Publication
(10) Pub. No.: US 2005/0253858 A1
(43) Pub. Date: Nov. 17, 2005

(54) Memory control system and method in which prefetch buffers are assigned uniquely to multiple burst streams

(76) Inventors: Takahide Ohkami, Newton, MA (US); John L. Redford, Cambridge, MA (US)

Correspondence Address: MILLS & ONELLO LLP, ELEVEN BEACON STREET, SUITE 605, BOSTON, MA, 02108, US

(21) Appl. No.: 10/846,995

(22) Filed: May 14, 2004

(51) Int. Cl. G09G 5/39; G06F 12/14

(52) U.S. Cl. 345/531

(57) ABSTRACT

In a prefetch buffering system and method, a pool of prefetch buffers are organized in such a manner that there is a tight connection between the buffer pool and the data streams of interest. In this manner, efficient prefetching of data from memory is achieved and the amount of required buffer space is reduced. A memory control system controls the reading of data from a memory. A plurality of buffers buffer data read from the memory. A buffer assignment unit assigns a plurality of data streams to the plurality of buffers. The buffer assignment unit assigns to each data stream a primary buffer and a secondary buffer of the plurality of buffers, such that upon receiving a data request from a first data stream, the primary buffer assigned to the first data stream contains fetch data of the data request and the secondary buffer assigned to the first data stream contains prefetch data of the data request.

### FIELD OF THE INVENTION

The present invention relates generally to a memory control system and a method for controlling a memory system, and more specifically to a system and method for improving the performance of memory read access processes for multiple burst streams using prefetch buffers.

### BACKGROUND OF THE INVENTION

Advances in semiconductor technologies have been driving the development of highly integrated semiconductor chips for a variety of applications. Many of these chips include multiple processing units and input/output units that operate in parallel. Such units perform read and write accesses to system memory devices, for example, dynamic random access memory (DRAM) devices, through an integrated memory controller. Synchronous DRAM devices (SDRAM) have become popular for use as system memory, since they are capable of operating at higher bandwidths. SDRAM designs are optimized for burst access, in which multiple blocks of contiguous data are read or written. Therefore, they are most effective for burst access, although they function well for both burst and non-burst access operations.

In order to take advantage of the beneficial features of SDRAM devices, a system bus configuration has been developed that supports the processing of burst transfers and that includes units that generate burst transfers in as many cases as possible. Many different types of such units, for example, processing units, input/output units and cache units, may be connected to the system bus and may request burst transfer access to system memory. A cache unit that operates in conjunction with a processing unit is an example of a burst-oriented unit that requires repeated access to blocks of consecutive data from the system memory using burst transfers via the system bus. In response to a burst write request, a memory controller queues the write data, which are transmitted to the SDRAM chips on a first-in first-out basis. The write operation is completed when the write data of a burst request has been entirely queued. In response to a burst read request, the memory controller employs one or more buffers to fetch consecutive data from the SDRAM chips before they are actually requested. This operation is referred to as a “prefetch” operation, and the associated buffers are referred to as “prefetch” buffers. When the data requested by the read request are found in a prefetch buffer, they are returned directly from the buffer in a much shorter time than from the SDRAM chips. This prefetch buffering technique effectively reduces the read latencies for burst read transfers.

A group of data transfers that are performed by a unit accessing the system bus, such as a processing unit, or an input/output unit, is referred to as a “stream”. The various input/output units and processing units connected to a system bus will often times attempt, through independent corresponding streams, to concurrently perform read data transfers from the system memory. In this case, the prefetch buffering technique may be less effective than expected because the data prefetched for a given stream may be destroyed by a different stream before the prefetched data are consumed. In such a case, the cycles consumed for the SDRAM access are wasted. In order to alleviate this problem, others have configured the memory controller to access a pool of buffers.

Although the buffer pool approach improves the memory read latencies for multiple burst streams, it still has several limitations. One limitation is that the buffer pool approach is ineffective if the buffer pool is not large enough for the number of active burst streams. If one prefetch buffer is used for multiple streams there is more of a likelihood that the data that are prefetched will be destroyed before they are consumed. Another limitation with this approach is that a unit that performs sporadic burst transfers does not receive a substantial performance improvement, since any data prefetched for that unit are destroyed, before they are consumed, by burst transfer requests from other units that perform more frequent transfers. Yet another limitation with this approach is that a unit with multithreading capability, or the ability to generate more than one stream, may monopolize multiple prefetch buffers, each being designated to one of the multiple streams.

In order to alleviate the above limitations, memory controllers can employ a priority technique such that a stream with a higher priority can pre-empty a prefetch buffer used by a stream with a lower priority. This priority technique is ineffective for many applications, since the assignment of priorities to the streams is complicated for achieving desired performance. In addition, the priority technique increases the complexity of the prefetch buffer control.

### SUMMARY OF THE INVENTION

The present invention provides a prefetch buffering solution, for example, for a system that includes a plurality of units that request burst read access to a system memory via a system bus, in a manner that addresses the limitations of the conventional approaches. A pool of prefetch buffers are organized in such a manner that there is a tight connection between the buffer pool and the data streams of interest. Thus, efficient prefetching of data from memory is achieved in a manner that reduces the amount of required buffer space.

In one aspect, the present invention is directed to a memory control system for controlling the reading of data from a memory. A plurality of buffers buffer data read from the memory. A buffer assignment unit assigns a plurality of data streams to the plurality of buffers. The buffer assignment unit assigns to each data stream a primary buffer and a secondary buffer of the plurality of buffers, such that upon receiving a data request from a first data stream, the primary buffer assigned to the first data stream contains fetch data of the data request and the secondary buffer assigned to the first data stream contains prefetch data for a subsequent data request.

In one embodiment, the buffer assignment unit, following completion of a data transfer from the primary buffer, reassigns the secondary buffer of the first data stream as the primary buffer of the first data stream. Following completion of the data transfer from the primary buffer, the buffer assignment unit further reassigns the primary buffer of the first data stream as the secondary buffer of the first data stream.

In another embodiment, when the fetch data of the primary buffer has been read, the buffer assignment unit reassigns the primary buffer and secondary buffer such that the secondary buffer containing the fetch data is reassigned as the primary buffer and such that the primary buffer contains new prefetch data.

In another embodiment, the buffer assignment unit assigns the secondary buffer to the plurality of the data streams. Upon receiving a data request from a second data stream, the primary buffer assigned to the second data stream contains fetch data of the data request and the secondary buffer assigned to the second data stream contains prefetch data for a subsequent data request from the second data stream. The secondary buffer assigned to the second data stream and the secondary buffer assigned to the first data stream are the same buffer of the plurality of buffers.

In another embodiment, the buffer assignment unit, following completion of a data transfer from the primary buffer assigned to the second data stream, reassigns the secondary buffer of the second data stream as the primary buffer of the second data stream. Following completion of the data transfer from the primary buffer assigned to the second data stream, the buffer assignment unit further reassigns the primary buffer of the second data stream as the secondary buffer of the second data stream.

In another embodiment, the fetch data of the primary buffer assigned to the second data stream has been read, the buffer assignment unit reassigns the primary buffer assigned to the second data stream and the secondary buffer assigned to the second data stream such that the secondary buffer containing the fetch data is reassigned as the primary buffer and such that the primary buffer contains new prefetch data.

In another embodiment, at least one of the plurality of data streams comprises a high-performance data stream and the buffer assignment unit assigns at least one of the plurality of buffers to the high-performance data stream to allow for continuous access to at least one of the buffers by a requestor unit of the high-performance data stream. The high-performance data stream comprises a data stream that is requested by at least one of the following types of requestor units: microprocessor, cache, and direct memory access (DMA).

In another embodiment, a plurality of the data streams comprise low-performance data streams and the buffer assignment unit manages access to one of the plurality of buffers among the low-performance requestor streams. The low-performance data stream comprises a data stream that is requested by at least one of the following types of requester units: video output, audio output, network output, and co-processor output.

The memory comprises a memory that is external to the memory control system.

In another aspect, the present invention is directed to a memory control system for controlling the reading of data from a memory. A plurality of read buffers buffer data read from the memory in response to read requests from a plurality of data streams. A buffer assignment unit assigns to each of the plurality of data streams a primary buffer of the plurality of read buffers. The buffer assignment unit further assigns a secondary buffer of the plurality of read buffers to the plurality of data steams, such that each of the plurality of data streams is assigned a unique primary buffer and such that the secondary buffer is shared among the plurality of data streams.

In one embodiment, when a read request is received from a data stream, and the requested data is contained in the primary buffer assigned to the data stream, the requested data is transferred from the primary buffer to the data stream, and, if a last data element of the primary buffer is to be read as a result of the request, a prefetch operation is initiated to transfer data from the memory to the secondary buffer. The assignments of the primary buffer and the secondary buffer are transposed as a result of the prefetch operation.

In one embodiment, the memory control system further comprises a memory interface unit for managing signal exchange between the memory control system and the memory during a memory read operation. A system bus control unit is included for managing signal exchange between the memory control system and a system bus on which the read requests are received for the plurality of data streams. The read buffers each include a buffer tag that receives a read address from the read request and determines whether a HIT or MISHIT condition occurs in the read buffer and determines whether the requested data is ready for transfer to the data stream. The read buffers each further include a register array for storing buffered data, a write pointer that stores the location of the register array available for the next write operation, and a read pointer that stores the location of the register array available for the next read operation.

In one embodiment, when a read request is received from a data stream, the primary buffer and the secondary buffer assigned to the data stream are inspected to determined whether the requested data is available in either the primary buffer or the secondary buffer.

In one embodiment, the read buffers are of a size that is one data element greater than a standard data block size, for example, the read buffers are 68 bytes in size, and the standard data block size is 64 bytes.

In another aspect, the present invention is directed to a method for controlling the reading of data from a memory. The method comprises assigning a plurality of data streams to a plurality of buffers that buffer data read from the memory; and assigning to each data stream a primary buffer and a secondary buffer of the plurality of buffers, such that upon receiving a data request from a first data stream, the primary buffer assigned to the first data stream contains fetch data of the data request and the secondary buffer assigned to the first data stream contains prefetch data of the data request.

In another aspect, the present invention is directed to a method for controlling the reading of data from a memory. The method comprises buffering data read from the memory a plurality of read buffers in response to read requests from a plurality of data streams; assigning to each of the plurality of data streams a primary buffer of the plurality of read buffers; and assigning a secondary buffer of the plurality of read buffers to the plurality of data steams, such that each of the plurality of data streams is assigned a unique primary buffer and such that the secondary buffer is shared among the plurality of data streams.

### BRIEF DESCRIPTION OF THE DRAWINGS

The foregoing and other objects, features and advantages of the invention will be apparent from the more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of a memory control system including a prefetch buffer controller in accordance with the present invention;

FIG. 2 is a block diagram of an on-chip system utilizing the memory control system of FIG. 1, in accordance with the present invention;

FIG. 3 is a block diagram illustrating interface signals that are transmitted between the system bus control unit, the read buffers and control unit, and the write buffers and control unit, in accordance with the present invention;

FIG. 4 is a pseudo-code representation of a finite state machine for the system bus control unit, in accordance with the present invention;

FIG. 5 is a block diagram that illustrates interface signals between the SDRAM control unit, the prefetch buffer unit, and the write buffers and control unit, in accordance with the present invention;

FIG. 6 is a pseudo-code representation of a finite state machine for the SDRAM control unit, in accordance with the present invention;

FIG. 7 is a block diagram of a data buffer of the read buffers and control unit, in accordance with the present invention;

FIG. 8 is a block diagram of a buffer tag of the read buffers and control unit, in accordance with the present invention;

FIG. 9 is a block diagram illustrating buffer assignment control in the read buffers and control unit, in accordance with the present invention;

FIG. 10 is a table illustrating assignment of the primary and secondary buffers for each stream, in accordance with the present invention;

FIG. 11 is a pseudo-code representation of the operation of the prefetch buffer, in accordance with the present invention;

FIG. 12 is an example sequence of read requests and resulting prefetch buffer operations, in accordance with the present invention;

FIG. 13 is a table of the primary and secondary buffer status corresponding to the sequence of FIG. 12, in accordance with the present invention;

FIG. 14 is a block diagram that illustrates the changing assignment of primary buffers and the secondary buffer to each of the physical prefetch buffers in response to the order of requests from the data streams, in accordance with the present invention.

FIG. 15 is a pseudo-code representation of the finite state machine for prefetch control, in accordance with the present invention;

FIG. 16 is a pseudo-code representation of the operation of a prefetch buffer during a single read operation, in accordance with the present invention;

FIG. 17 is a pseudo-code representation of the operation of a prefetch buffer having dedicated buffers, in accordance with the present invention;

FIG. 18 is a pseudo-code representation of the operation of a prefetch buffer undergoing 2-byte burst reads, in accordance with the present invention; and

FIG. 19 is a diagram that illustrates data prefetching into buffers with different buffer sizes, in accordance with the present invention.

### DETAILED DESCRIPTION OF PREFERRED EMBODIMENTS

The present invention is directed to a memory control system and method that increase the efficiency of read burst operations in systems that include multiple data streams.

In one embodiment, for a system including N high-performance burst streams and M low-performance burst streams, a plurality of prefetch buffers, for example, N+2 prefetch buffers, are provided, each of which includes a data buffer and a buffer tag. A prefetch controller maintains the N+2 prefetch buffers, which are uniquely assigned at any moment to a given burst stream, or multiple burst streams. In one example, N prefetch buffers are uniquely assigned to N corresponding high-performance burst streams, such that each of the high-performance burst streams has a designated buffer. One buffer, for example the N+1^{st} buffer, is designated to be shared by the low-performance burst streams, and one buffer, for example the N+2^{nd} buffer, is designated as a secondary, or “temporary” buffer. The prefetch controller pairs two buffers as the primary and secondary buffers for the handling of prefetch operations. In this manner, data can be prefetched from memory into the secondary buffer while previously read data is transmitted from the primary buffer to the requesting unit. For example, for each high-performance burst stream, the assigned one of the N buffers and the temporary buffer are used as the primary and secondary buffers, respectively, while for the slow burst streams, the shared buffer and the temporary buffers are used as the primary and secondary buffers. Following initial designations, the assignment of the physical prefetch buffers to the various buffer streams as the primary and secondary buffers of such streams can continue to change, and is controlled by the prefetch controller. Such reassignment of the physical prefetch buffers is described in further detail below.

The buffer tag contains information related to the data items stored in the corresponding data buffer. This information includes, for example, a valid bit, a buffer base address, a buffer max address, and a buffer limit address. The valid bit indicates whether or not the data items stored in the data buffer are valid. The buffer base address is the address of the first data element stored in the data buffer, while the buffer max address is the buffer base address added to the buffer size, or the total byte count of data stored in the data buffer. The buffer limit address is the buffer base address added to the byte count of data available in the data buffer. For each read request, the buffer tag signals a “hit” or “mishit”. A hit is signaled if the valid bit is active and if the requested address is greater than or equal to the buffer base address and less than the buffer max address; otherwise, a mishit is signaled. The buffer tag also signals ready for the requested data if the address of the data is less than the buffer limit address, indicating that the data is available in the data buffer.

In one example, when a burst read requester initiates the request of K bytes of data from system memory, a prefetch request is made by the prefetch controller, where K is less than, equal to, or greater than, the prefetch buffer size. The request can either result in the signaling of a hit or mishit in the buffer tag.

A mishit is generated when a mishit is signaled by the primary buffer assigned to the requesting data stream. In this case, the prefetch controller loads the prefetch buffer assigned as the primary buffer for the stream with the K bytes of data beginning with the requested address, assuming that K is less than the buffer size. The requested data are provided to the requesting data stream by the primary buffer as the data become available. Assuming that K is greater than or equal to the buffer size, the prefetch controller first loads the prefetch buffer assigned as the primary buffer for the stream with the K bytes of data beginning with the requested address and then loads the secondary buffer with the remaining portion of the K bytes of data and the following data to fill the buffer. All the requested data are returned from the primary buffer as the data become available. The assignment of the primary and secondary buffers is switched when the last data item is consumed in the primary buffer. In both cases, the prefetch buffer assigned as the primary buffer stores the data prefetched for subsequent read requests.

A hit is generated when a hit is signaled by the primary buffer assigned to the requesting data stream. If the first L bytes out of the requested K bytes are available in the primary buffer, then the prefetch controller fully loads the secondary buffer with a block of bytes of data beginning with the first missing byte. The assignments of the primary and secondary buffers are then switched by the prefetch controller. In this case, the first L bytes are provided to the requesting data stream by the primary buffer, and the remainder are provided by the secondary buffer after it has been reassigned as the primary buffer by the prefetch controller. If the request address plus K bytes is equal to the maximum address of the primary buffer, then all K bytes are returned to the requesting data stream by the primary buffer. In this case, the prefetch controller loads the secondary buffer with the bytes following the requested bytes and switches the assignment of the primary and secondary buffers at the end of the operation. In both cases, the prefetch buffer assigned to the primary buffer stores the data prefetched for subsequent read requests.

The above describes basic prefetch operations in accordance with embodiments of the present invention. Several variations of the basic prefetch operations are possible, depending on application.

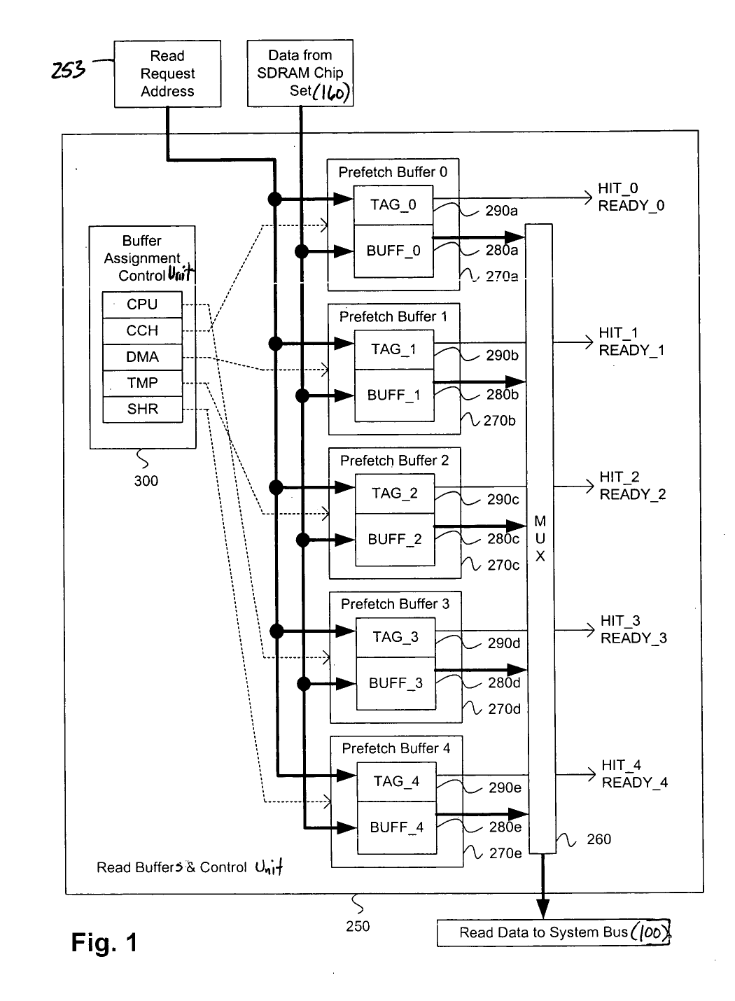

FIG. 1 is a block diagram of a memory control system including a prefetch buffer, in accordance with the present invention. A read buffers and control unit 250 includes a data multiplexer 260, five prefetch buffers 270a, 270b, 270c, 270d, 270e, each including a corresponding data buffer 280a, 280b, 280c, 280d, 280e and each including a corresponding buffer tag 290a, 290b, 290c, 290d, 290e, and a buffer assignment control unit 300. Each of the data buffers 280a-280e stores data read from the external memory, for example, the SDRAM chip set 160.

The buffer assignment control unit 300 assigns the five physical prefetch buffers 270a-270e uniquely as the buffers to be associated with the various requester unit data streams. The central processing unit (CPU), cache memory unit (CCH) and direct memory access (DMA) streams refer to high-performance data streams that are each assigned a unique prefetch buffer of the prefetch buffers 270a-270e by the buffer assignment control unit 300. The buffer assignment control unit 300 also assigns one of the prefetch buffers 270a-270e as the temporary buffer (TMP). In addition, the buffer assignment control unit 300 assigns one of the prefetch buffers 270a-270e as a shared buffer (SHR) for shared use by multiple low-performance streams. In the example of FIG. 1, prefetch buffers 270a-270e are presently assigned as the CCH, DMA, TMP, CPU, and SHR buffers, respectively. As will be described below, the buffer assignment control unit continually changes the assignment of the various streams to the various buffers 270a-270e; however, at any given moment, each type of stream is assigned to a unique buffer.

When the requested data are present in a data buffer, a hit occurs at the buffer tag 290a-290e, and the data are transmitted via the data multiplexer 260 to the system bus 100. To determine whether the data are present, the read request address 253 is compared with the buffer tags 290a-290e to determine whether any of the corresponding data buffers 280a-280e contain the requested data. In response to the comparison, the buffer tag 290a-290e generates a hit signal and a ready signal. The hit signal indicates that the requested data is, or will be, present in the data buffer, while the ready signal indicates that the requested data is presently available in the data buffer.

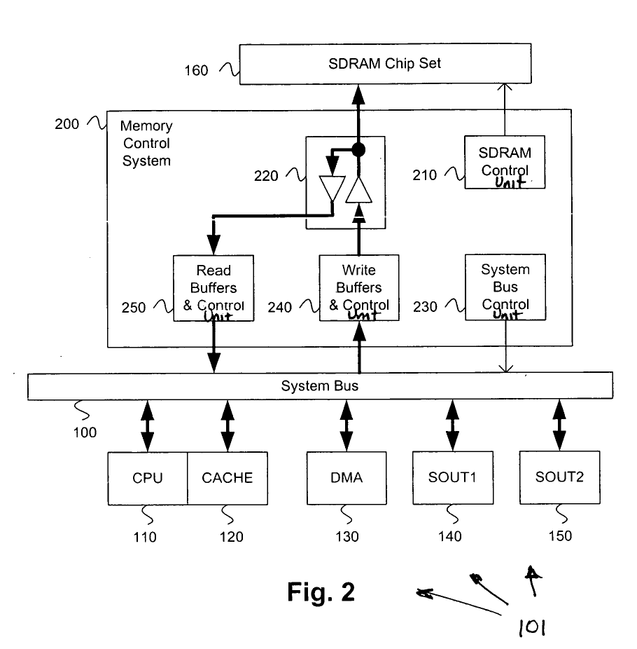

FIG. 2 is a block diagram of an on-chip system including a memory control system 200. A system bus 100 connects a plurality of bus masters 101 including a central processing unit (CPU) 110, a cache memory (CACHE) 120, a direct memory access unit (DMA) 130, a first low-performance output unit (SOUT1) 140, a second low-performance output unit 2 (SOUT2) 150, with a memory control system 200 including associated system memory in the form of an SDRAM chip set 160 including one or more SDRAM devices. The memory control system 200 is coupled between the system bus 100 and the SDRAM chip set 160. The memory control system 200 includes an SDRAM control unit 210, an SDRAM data input/output unit 220, a system bus control unit 230, a write buffers and control unit 240, and a read buffers and control unit 250.

The memory control system 200 operates as a bus slave device on the system bus 100. It responds to memory read and write requests generated by the bus master devices 101 that are the requestors of the data streams, namely the CPU 110, CACHE 120, DMA 130, SOUT1 140, and SOUT2 150 devices. The system bus control 230 operates to control the interface signals for interfacing the memory control system 200 with the system bus 100.

The memory control system 200 initiates read and write operations with the SDRAM chip set 160 in order to fulfill the requests generated by the bus master devices. The SDRAM control unit 210 operates to control the interface signals for interfacing with the SDRAM chip set 160.

When the memory control system 200 receives a memory write request from one of the bus masters 101 connected to the system bus 100, the request and the associated write data are queued in the write buffers and control unit 240. The write buffers and control unit 240 transmits the write data through the SDRAM data input/output unit 220 to the SDRAM chip set 160 to complete the write operation. The SDRAM control unit 210 manages the signal interface and handshaking that needs to occur for the exchange of write and read data between the SDRAM chip set 160 and the memory control system 200.

When the memory control system 200 receives a memory read request from one of the bus masters 101 connected to the system bus 100, the read data is returned from the read buffers and control unit 250 to the requesting bus master 101 via the system bus 100. When the read buffers and control unit 250 locates the requested data in the prefetch buffer assigned to the stream of the requestor bus master 101, the data is immediately returned from the prefetch buffer to the requestor bus master 101. If the requested data is absent from the prefetch buffer, the read buffers and control unit 250 initiates a read request to the SDRAM control unit 210 to read the requested, absent data from the SDRAM chip set 160. When the requested data becomes available in the prefetch buffer, the read buffers and control unit 250 returns the data to the requester bus master 101 via the system bus 100.

In one embodiment, the system bus 100 comprises an AMBA AHB system bus, as described in “AMBA Specification (Rev 2.0)” published in 1999 by ARM Limited. In one embodiment, the SDRAM chips used in the SDRAM chip set 160 comprise MT48LC32M8A2 memory units (256 Mb SDRAM with 8M*8 bits*4 banks) described in “256 Mb: ×4, ×8, ×16 SDRAM Data Sheet” published in 2003 by Micron Technology Inc. Other types of system buses and memory systems are equally applicable to the principles of the present invention.

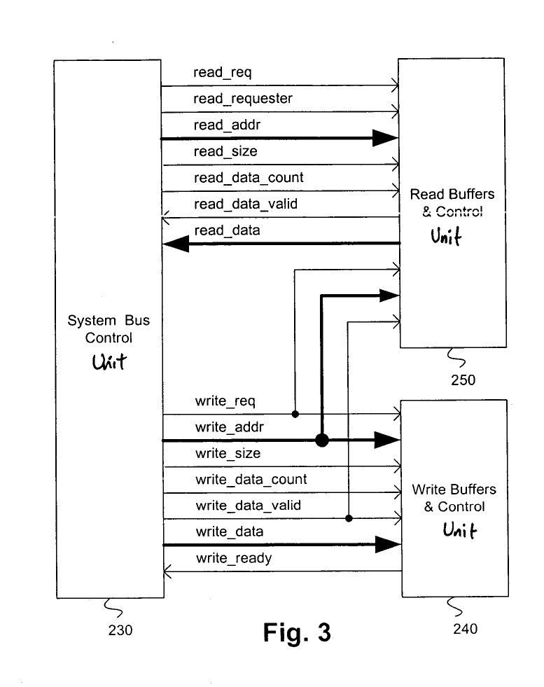

FIG. 3 is a block diagram that illustrates the interface signals that are exchanged between the system bus control unit 230, the read buffers and control unit 250, and the write buffers and control unit 240. In the diagram, the control signals are grouped according to the read and write signal groups. The system bus control unit 230 exchanges read operation related signals with the read buffers and control unit 250 and exchanges write operation related signals with the write buffers and control unit 240. The control signals accommodate burst requests for high-performance memory access, where a burst request, in general, requests that N data be read or written, where N is greater than or equal to 1. A burst request involving N data elements is referred to as an “N-beat” burst request. A 1-beat burst request is also referred to as a single request.

The read signals include read_req, read_requester, read_addr, read_size, read_data_count, read_data_valid, and read_data. The read_req signal is asserted when the system bus control unit 230 makes a read request to the read buffers and control unit 250. The read requester signal identifies the requesting bus master, which is used by the read buffers and control unit 250 for prefetch operations. The read_addr and read_size signals indicate the requested address and the data size, respectively, of the read data. The read_data_count signal indicates the number of data elements to read for the burst request. The read_data_valid signal is asserted when the requested data becomes available on the read_data signal lines. If the read_data_count value is N, then the read_data_valid signal is asserted N times for N read data elements. If the read data size indicated by the read_size signal is S bytes, then the total number of bytes to read for the burst request is N*S bytes.

The write signals include write_req, write_addr, write_size, write_data_count, write_data_valid, write_data, and write_ready. The write_req signal is asserted when the system bus control unit 230 makes a write request to the write buffers and control unit 240. The write_addr and write_size signals indicate the requested destination address and the data size, respectively, of the write data. The write_data_count signal indicates the number of data elements to write for the burst request. The write_ready signal is asserted whenever the write buffers and control unit 240 is ready to receive a write request. The write_data_valid signal is asserted when the write data is valid on the write_data signal lines. If the write_data_count value is N, then the write_data_valid signal is asserted N times for N write data elements. If the write data size indicated by the write_size signal is S bytes, then the total number of bytes to write for the burst request is N*S bytes.

The write_req, write_addr, and write_data_valid signals are also forwarded to the read buffers and control unit 250 for the purpose of prefetch buffer invalidation. When the write_req and write_data_valid signals are both asserted, the write_addr signal is examined by the read buffers and control unit 250. If the examination determines that there is a prefetch buffer that contains the data that was previously fetched from an address that matches the write_addr signal, then the read buffers and control unit 250 responds by invalidating the prefetch buffer.

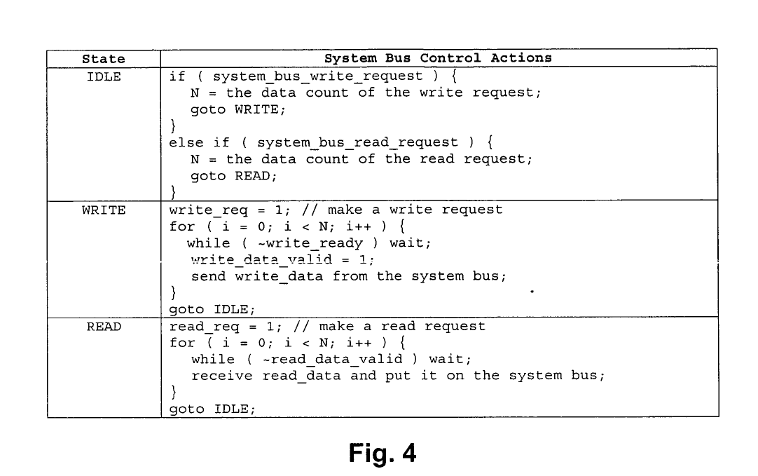

FIG. 4 is a pseudo-code representation of a finite state machine that controls operation in the system bus control unit 230. The finite state machine controls operation in three states: IDLE, WRITE, and READ. The finite state machine is in the IDLE state upon reset or initialization, and remains in the IDLE state while no read or write request is present. When an N-beat burst write request occurs, the finite state machine makes a state transition from IDLE to WRITE. In the WRITE state, the finite state machine sends N write data elements to the write buffers and control unit 240 while the write_ready signal is asserted. After sending N write data, the finite state machine returns to the IDLE state. When an N-beat read request occurs, the finite state machine makes a state transition from IDLE to READ. In the READ state, the finite state machine receives N read data elements while the read_data_valid signal is asserted by the read buffers and control unit 250 and forwards them to the system bus 100. After receiving N read data elements, the finite state machine returns to the IDLE state.

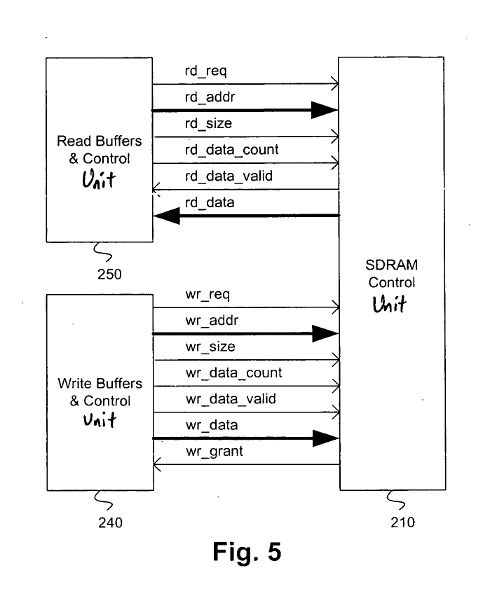

FIG. 5 is a block diagram that illustrates the control signals exchanged between the SDRAM control unit 210, the read buffers and control unit 250, and the write buffers and control unit 240. In the diagram, the control signals are grouped according to the read and write signal groups. The SDRAM control unit 210 exchanges the read control signals with the read buffers and control unit 250 and exchanges the write control signals with the write buffers and control unit 240.

The read signals include rd_req, rd_addr, rd_size, rd_data_count, rd_data_valid, and rd_data signals. These signals functionally correspond to the read_req, read_addr, read_size, read_data_count, read_data valid and read_data signals respectively, exchanged between the system bus control unit 230 and the read buffers and control unit 250 in FIG. 3.

The write signals include wr_req, wr_addr, wr_size, wr_data_count, wr_data_valid, wr_data, and wr_grant signals. The write signals other than the wr_grant signal functionally correspond to the write_req, write_addr, write_size, write_data_count, write_data_valid, and write_data signals respectively, exchanged between the system bus control unit 230 and the write buffers and control unit 240 in FIG. 3. The SDRAM control unit 210 asserts the wr_grant signal when it has completed processing the write data. For an N-beat burst write request, the write buffers and control unit 240 will receive an asserted wr_grant signal N times.

In one embodiment, the SDRAM control unit 210 gives a higher priority to a write request from the write buffers and control unit 240 than to a read request from the read buffers and control unit 250.

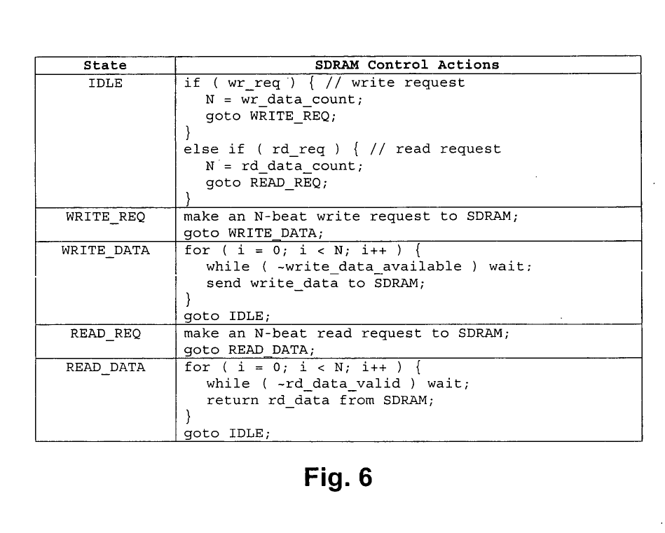

FIG. 6 is a pseudo-code representation of a finite state machine that controls operation in the SDRAM control unit 210. The finite state machine controls operations in five states: IDLE, WRITE_REQ, WRITE_DATA, READ_REQ, and READ_DATA. The finite state machine is placed into the IDLE state upon reset or initialization. It remains in the IDLE state while no request has been made. The finite state machine changes state from IDLE to WRITE_REQ upon receiving an N-beat burst write request, and changes state from IDLE to READ_REQ upon receiving an N-beat burst read request.

In the WRITE_REQ state, the SDRAM control unit 210 finite state machine makes an N-beat write request to the SDRAM chip set 160 and changes state to the WRITE_DATA state, during which time N write data elements are sent to the SDRAM chip set 160 when the write data are available with the wr_data_valid signal asserted. After sending N write data elements, the finite state machine returns to the IDLE state.

In the READ_REQ state, the SDRAM control unit 210 finite state machine makes an N-beat read request to the SDRAM chip set 160 and changes state to the READ_DATA state, during which time N read data elements are received from the SDRAM chip set 160 when the read data are available with the rd_data_valid signal asserted. After receiving N read data elements, the finite state machine returns to the IDLE state.

The SDRAM operations involving the control of the signals, such as CKE (clock enable), CS (chip select), RAS (row address strobe), CAS (column address strobe), WE (write enable), A (address), BA (bank address), DQM (input/output data mask), and DQ (data input/output), are described in the SDRAM data sheet corresponding to the SDRAM chip set 160, and will be readily translated from the above-described operations by one skilled in the art.

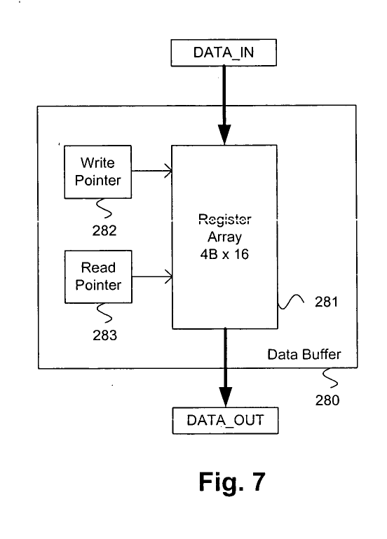

FIG. 7 is a block diagram of a data buffer 280 of one of the prefetch buffers 270 of the read buffers and control unit 250 of FIG. 1 above. The data buffer 280 comprises a register array 281, a write pointer 282, and a read pointer 283. In one embodiment, the register array 281 stores 16 consecutive 4-byte data elements. The write pointer 282 points to the data location of the array 281 available for the next write operation, and is updated when a write operation is performed. The read pointer 283 points to the data location for the current read operation and is updated when a read operation is performed. In this exemplary embodiment, the read and write operations are performed in units of 4 bytes. Other data unit sizes are equally applicable to systems and methods of the present invention.

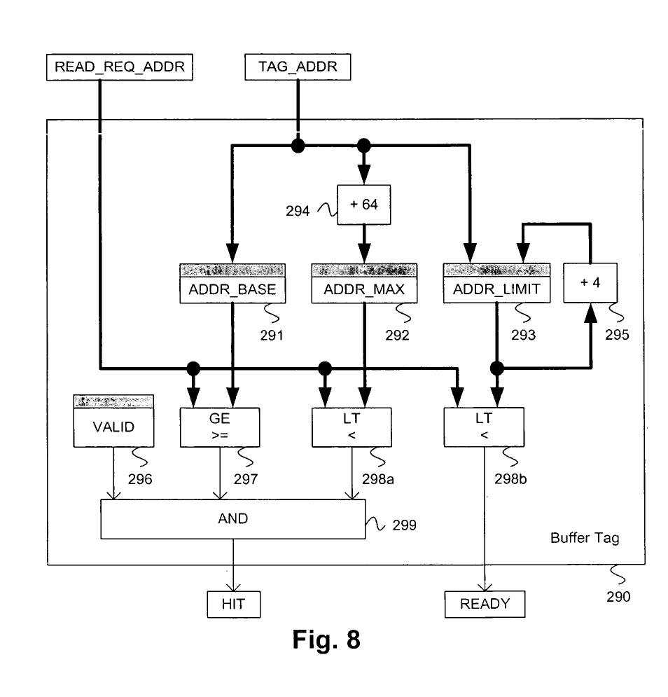

FIG. 8 is a block diagram of a buffer tag 290 of one of the prefetch buffers 270 of the read buffers and control unit 250 of FIG. 1. The buffer tag 290 includes four registers ADDR_BASE 291, ADDR_MAX 292, ADDR_LIMIT 293, and VALID 296. The ADDR_BASE register 291 stores the base address of the first 4-byte data element stored in the associated data buffer. The ADDR_MAX register 292 stores the base address plus the size of the data buffer (64 bytes in this example). The ADDR_LIMIT register 293 stores the base address plus the number of data bytes available in the data buffer. The VALID register 296 stores the valid bit, which indicates whether the data buffer contains valid data. The valid bit is initially inactive.

Each time a fetch or prefetch operation is initiated, the values stored in the four registers are updated. When a new tag address TAG_ADDR is stored into the ADDR_BASE register 291, the ADDR_MAX register 292 is loaded with the value generated by adding 64 (the data buffer size, in bytes) to the base address in the adder 294. The base address is also loaded into the ADDR_LIMIT register 293. Adder 295 increments the value stored in ADDR_LIMIT 293 by 4. The incremented value is stored into the ADDR_LIMIT register 293 each time a 4-byte data element is stored in the corresponding data buffer. The value in the ADDR_LIMIT register 293 becomes equal to the value in ADDR_MAX register 292 in this example when sixteen 4-byte data elements are stored in the data buffer.

When a read request is received, the read request address READ_REQ_ADDR is compared to the value stored in the ADDR_BASE register 291 by comparator 297 and compared to the value stored in the ADDR_MAX register 292 by comparator 298a. The output of comparator 297 is active if the read request address is greater than or equal to the base address stored in the ADDR_BASE register 291, while the output of comparator 298a is active if the read request address is less than the value stored in the ADDR_MAX register 292. These two comparator output signals are combined in an AND operation along with the valid bit recorded in the VALID register 296 by an AND gate 299. The output of the AND gate 299 is the HIT signal. An active HIT signal indicates that the associated data buffer contains the valid data and that the read request address is within the range of the prefetch buffer, that is, the requested data is, or will be, stored in the associated data buffer.

The read request address READ_REQ_ADDR is also compared with the value stored in the ADDR_LIMIT register 293 at comparator 298b. The output of the comparator 298b is the READY signal. The READY signal is asserted when the requested data becomes available in the associated data buffer.

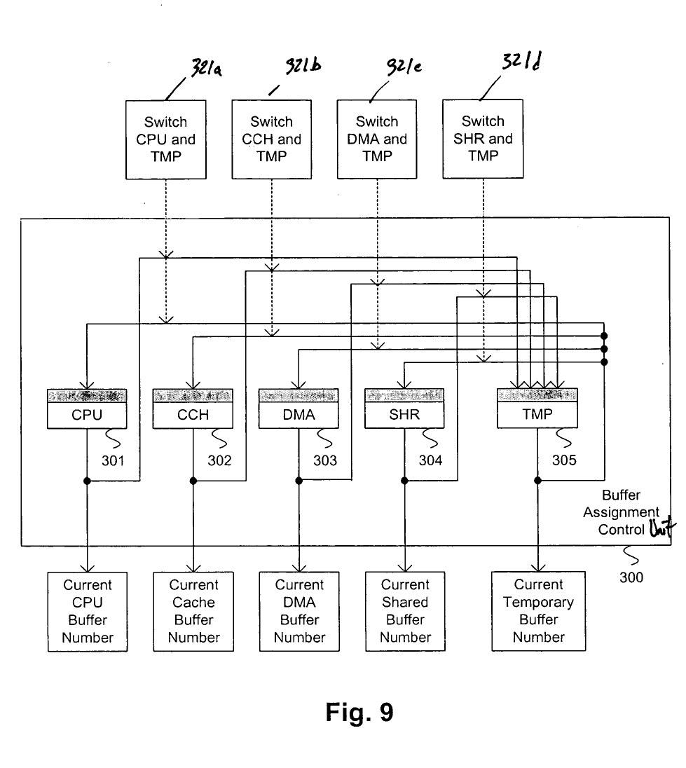

FIG. 9 is a block diagram of the buffer assignment control unit 300 in the read buffers and control unit 250 of FIG. 1. In the present embodiment, the buffer assignment control unit 300 includes five registers CPU 301, CCH 302, DMA 303, SHR 304, and TMP 305. The CPU register 301 stores the number, or index, of the prefetch buffer currently assigned to the data stream from the CPU master unit 110, the CCH 302 register stores the number, or index, of the prefetch buffer currently assigned to the data stream from the CACHE master unit 120, and the DMA register 303 the number, or index, of the prefetch buffer currently assigned to the data stream from the DMA master unit 130. The SHR register 304 stores the number of the prefetch buffer that is currently shared by the data streams from the SOUT1 140 and SOUT2 150 master units. The TMP 305 register stores the number of the prefetch buffer currently assigned as a temporary buffer. The prefetch buffer assignments are unique at any moment during operation. A switch signal 321a, 321b, 321c, 321d transposes the assignments of any of the non-temporary buffers (CPU, CCH, DMA, and SRH) with the temporary buffer TMP. There are four switch signals: CPU and TMP 321a, CCH and TMP 321b, DMA and TMP 321c, and SHR and TMP 321d.

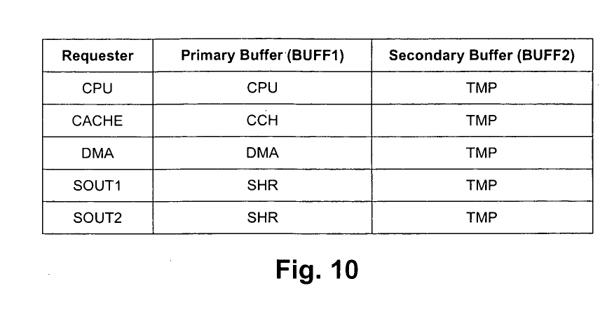

FIG. 10 is a table illustrating the assignment of primary and secondary buffers for each data stream. In this embodiment, the primary and secondary buffers are paired to process a read stream for a master unit requesting the data. The primary buffer or BUFF1 is the current buffer that stores the prefetched data to be consumed by the next read request, while the secondary buffer or BUFF2 is the temporary buffer that stores the following data. Note that in this example, the prefetch buffer presently assigned as the temporary buffer TMP is always the secondary buffer for each stream.

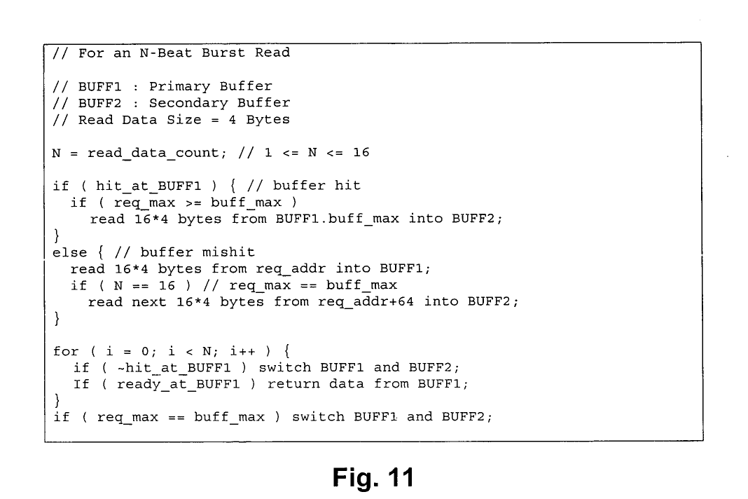

FIG. 11 is a pseudocode representation of the operation of the read buffers and control unit 250 to fulfill an N-beat burst read request from a stream of a master unit. In this example, the read data size is assumed to be 4 bytes. It is also assumed that N is less than or equal to 16 so that the total byte count of the request does not exceed the buffer size (64 bytes).

When a read request is received, the primary buffer currently assigned to the stream determines whether the requested address results in a HIT. The hit_at_BUFF1 is the HIT signal generated by the buffer tag 290 in the prefetch buffer 270 designated as the primary buffer of the stream. If the hit_at_BUFF1 signal is asserted, the req_max value is compared with the buff_max value. The req_max value is the request address plus the total byte count of the request, while the buff_max value is the value stored in the ADDR_MAX 292 register in the buffer tag 290 corresponding to the primary buffer. If the req_max value is greater than or equal to the buff_max value, indicating that the last data element stored in the primary buffer is consumed by this request, the read buffers and control unit 250 reads an additional 64 bytes from the external memory 160, beginning with the buff_max address, into the secondary buffer, or TMP buffer, of the stream; in other words, the read buffers and control unit 250 performs a prefetch operation.

If the hit_at_BUFF1 signal is not asserted, indicating that a MISHIT has occurred, the read buffers and control unit 250 reads 64 bytes from the external memory 160, beginning with the request address, into the primary buffer. If N is equal to 16, indicating that the req_max value is equal to the buff_max value of the primary buffer, then the read buffers and control unit 250 performs a prefetch operation by reading the following 64 bytes from memory 160 into the secondary buffer.

The requested data are returned from the primary buffer if they are available in the primary buffer. If the requested data are absent from the primary buffer, the designations of the primary and secondary buffers are switched, or transposed, by the buffer assignment control unit 300. Any remaining data are then returned from the newly assigned primary buffer. At the end of an operation, the designations of the primary and secondary buffers are switched if the req_max value is equal to the buff_max value, which indicates that all data stored in the primary buffer has been read, and therefore, that buffer can now be reloaded with new data.

At the outset of a burst read request operation, the primary buffer stores, or will store, some or all of the requested data. If it does rot contain all of the requested data, the remaining portion of the requested data are found in the secondary buffer, which is switched to be designated as the primary buffer when the data from the former primary buffer have been read. This is guaranteed by the prefetch operation that is automatically initiated if the current request consumes the last data element stored in the primary buffer. In the case where all of the requested data are returned from the primary buffer and the last data element in the buffer is consumed, the primary and secondary buffers are once again transposed, since the data in the primary buffer has been completely read.

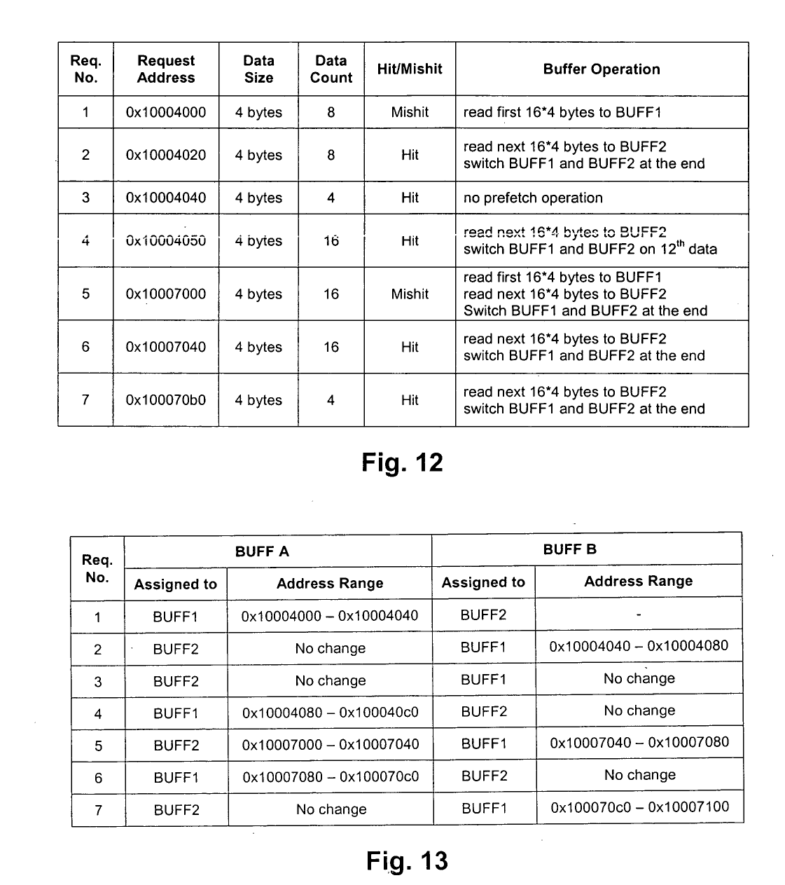

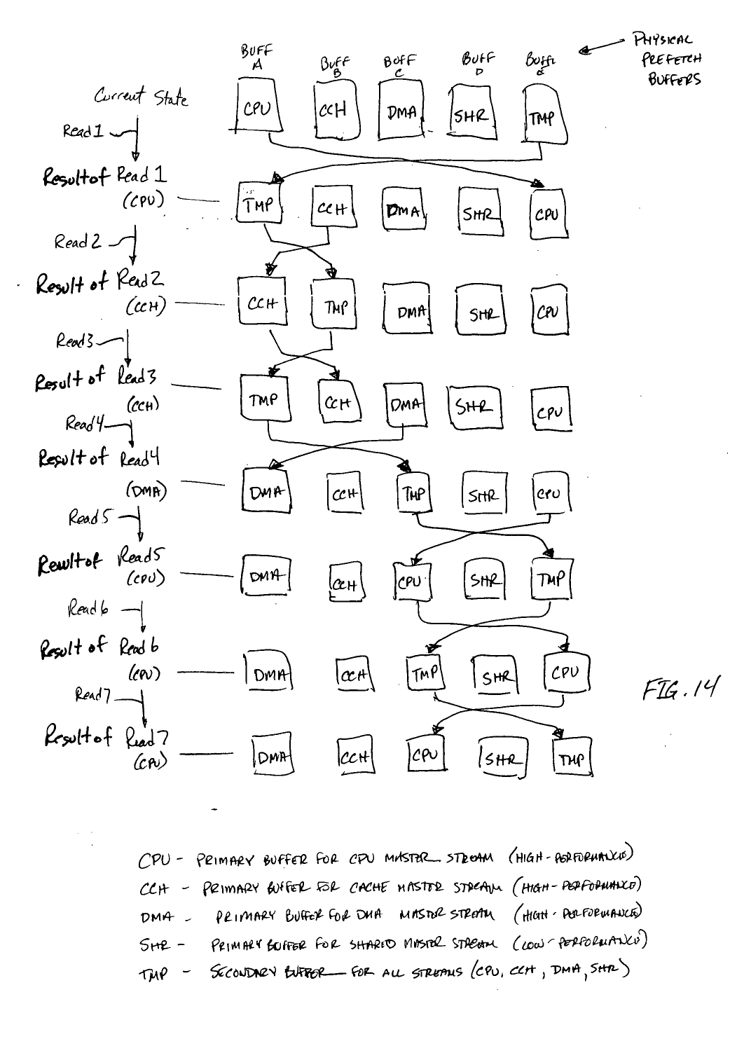

FIG. 12 is a table that illustrates an example sequence of burst read requests for a given data stream and the resulting operation of the read prefetch buffers and control unit 250 in managing the primary (BUFF1) and secondary buffers (BUFF2) for the stream, in accordance with the present invention. FIG. 13 is a table of the status of the primary and secondary buffers following each read request corresponding to the read operation sequence of FIG. 12, in accordance with the present invention. In FIG. 13 the primary and secondary buffers BUFF1, BUFF2 for the data stream are assigned to the physical prefetch buffers BUFFA, BUFFB, and it can be seen that the assignments are repeatedly switched or transposed, depending on the requested operation.

The first read request (Req. 1) is a request for 8 data elements of 4 bytes each, or a total of 32 bytes, beginning at address 0x10004000. This request results in a MISHIT because the data has not been read into the buffer. As a result of the MISHIT, a read operation of 64 bytes beginning with address 0x10004000 is initiated, for transfer into the primary buffer BUFF1. As shown in FIG. 13, during the initial request (Req. 1) primary buffer BUFF1 of the data stream is assigned to physical buffer BUFFA and secondary buffer BUFF2 of the data stream is assigned to physical buffer BUFFB. Following the read operation, data bytes associated with address range 0x1000400-0x10004040 are contained in physical buffer BUFFA. All 8 requested data elements (32 bytes in total) are then returned to the data stream from the primary buffer.

The second read request (Req. 2) is a request for 8 data elements of 4 bytes each, or a total of 32 bytes, beginning at address 0x10004020. In this case, the req_max value (0x10004020+0x20 (32 bytes)=0x10004040) is equal to the buff_max value of the primary buffer (0x10004000+0x40=0x10004040). All 8 requested data elements are therefore present in the primary buffer BUFF1 (currently assigned to physical buffer BUFFA), and therefore a HIT occurs. The requested data are returned tot the data stream from the primary buffer (BUFF1). Since this request consumes the last data element of the primary buffer, a prefetch operation is initiated, and the following 64 bytes, beginning with address 0x10004040 are read into the secondary buffer BUFF2 (currently assigned to physical buffer BUFFB). At the end of the prefetch read operation, the assignments of the primary BUFF1 and secondary BUFF2 buffers are transposed, such that the primary buffer BUFF1 is assigned to physical buffer BUFFB and such that the secondary buffer BUFF2 is assigned to the physical buffer BUFFA, as shown in FIG. 13. Following the read request operation, the new primary buffer BUFF1 (now assigned to physical buffer BUFFB) stores 64 bytes of sequential prefetched data, beginning with address 0x10004040 and through address 0x10004080.

The third read request (Req. 3) is a request for 4 data elements of 4 bytes each, or a total of 16 bytes, beginning at address 0x10004040. Since all the requested data are found in the primary buffer BUFF1 (assigned to physical buffer BUFFB), a HIT occurs, and the requested data are returned to the data stream from the from the primary buffer BUFF1. Since the last data element available in the primary buffer is not consumed by this request, no prefetch operation is performed as a result of this request.

The fourth read request (Req. 4) is a request for 16 data elements of 4 bytes each, or a total of 64 bytes, beginning at address 0x10004050. Since data beginning with this address are found in the primary buffer BUFF1 (assigned to physical buffer BUFFB), a HIT occurs. In this case, the req_max value (0x10004050+0x40=0x10004090) is greater than the buff_max value (0x10004040+0x40=0x10004080) of the primary buffer BUFF1 (assigned to physical buffer BUFFB). Therefore, a prefetch operation is initiated to read the following sequential 64 bytes beginning with address 0x10004080 into the secondary buffer BUFF2 (assigned to physical buffer BUFFA). After the first 12 data elements (48 bytes) are returned to the data steam from the primary buffer BUFF1, the assignments of the primary BUFF1 and secondary BUFF2 buffers are transposed, such that the primary buffer BUFF1 is once again assigned to physical buffer BUFFA and such that the secondary buffer BUFF2 is once again assigned to the physical buffer BUFFB, as shown in FIG. 13. The remaining 4 data elements are then returned to the data stream from the new primary buffer BUFF1 (now reassigned to physical buffer BUFFA).

The fifth read request (Req. 5) is a request for 16 data elements of 4 bytes each, or a total of 64 bytes, beginning at new, non-sequential address 0x10007000. Since the data beginning with this address is not available in the primary buffer BUFF1, this operation results in a MISHIT. The 64 bytes of data beginning with address 0x10007000 are read into the primary buffer BUFF1 (assigned to physical buffer BUFFA) from memory. Since the read request consumes the last data element available in the primary buffer BUFF1, a prefetch operation is initiated and the following sequential 64 bytes are stored into the secondary buffer BUFF2 (assigned to physical buffer BUFFB). After the requested 16 data elements (64 bytes) are returned to the data steam from the primary buffer BUFF1, the assignments of the primary BUFF1 and secondary BUFF2 buffers are transposed, such that the primary buffer BUFF1 is assigned to physical buffer BUFFB and such that the secondary buffer BUFF2 is assigned to the physical buffer BUFFA, as shown in FIG. 13. The new primary buffer BUFF1 (now assigned to physical buffer BUFFB contains 16 elements (64 bytes) of prefetched data retrieved from addresses 0x10007040-0x10007080.

The sixth read request (Req. 6) is a request for 16 data elements of 4 bytes each, or a total of 64 bytes, beginning at sequential address 0x10007080. Since the data beginning with this address is available in the primary buffer BUFF1 (assigned to physical buffer BUFFB), this operation results in a HIT. Since the read request consumes the last data element available in the primary buffer BUFF1, a prefetch operation is initiated and the following sequential 64 bytes are stored into the secondary buffer BUFF2 (assigned to physical buffer BUFFA). After the requested 16 data elements (64 bytes) are returned to the data steam from the primary buffer BUFF1, the assignments of the primary BUFF1 and secondary BUFF2 buffers are transposed, such that the primary buffer BUFF1 is assigned to physical buffer BUFFA and such that the secondary buffer BUFF2 is assigned to the physical buffer BUFFB, as shown in FIG. 13. The new primary buffer BUFF1 (now assigned to physical buffer BUFFA contains 16 elements (64 bytes) of prefetched data retrieved from addresses 0x10007080-0x100070c0.

The seventh read request (Req. 7) is a request for 4 data elements of 4 bytes each, or a total of 16 bytes, beginning at sequential address 0x100070b0. Since the data beginning with this address is available in the primary buffer BUFF1 (assigned to physical buffer BUFFA), this operation results in a HIT. Since the read request consumes the last data element available in the primary buffer BUFF1, a prefetch operation is initiated and the following sequential 64 bytes are stored into the secondary buffer BUFF2 (assigned to physical buffer BUFFB). After the requested 4 data elements (64 bytes) are returned to the data steam from the primary buffer BUFF1, the assignments of the primary BUFF1 and secondary BUFF2 buffers are transposed, such that the primary buffer BUFF1 is assigned to physical buffer BUFFB and such that the secondary buffer BUFF2 is assigned to the physical buffer BUFFA, as shown in FIG. 13. The new primary buffer BUFF1 (now assigned to physical buffer BUFFB contains 16 elements (64 bytes) of prefetched data retrieved from addresses 0x100070c0-0x10007100.

In this manner, the systems and method of the present invention operate to perform a prefetch operation into the secondary buffer if it is determined that the last data element of the primary buffer will be consumed by a read operation initiated by the data stream. In addition, the assignment of the primary and secondary buffers (BUFF1, BUFF2) of the stream to first and second physical prefetch buffers (BUFFA, BUFFB) is transposed when the last data element of the primary buffer has been read to the requesting data stream.

The above example of FIG. 13 assumes that only one of the streams is requesting data from the read buffers and control unit 250. Therefore, in this case, the assignment of the primary and secondary buffers (BUFF1, BUFF2) toggle between the first and second physical prefetch buffers.

However, as described above, the systems and methods of the present invention allow for read operations from a number of independent data streams to be serviced by a plurality of physical prefetch buffers. For example, in the above example of FIG. 10, three physical buffers (assume as BUFFA, BUFFB, and BUFFC) are assigned as primary buffers BUFF1 for the CPU, CACHE and DMA high-performance data requestor streams. One physical buffer BUFFD is assigned as a primary buffer for the shared SOUT1 and SOUT2 low-performance data requestor streams. Also, one physical buffer BUFFE is assigned as a secondary buffer BUFF2 that operates in conjunction with all of the primary buffers.

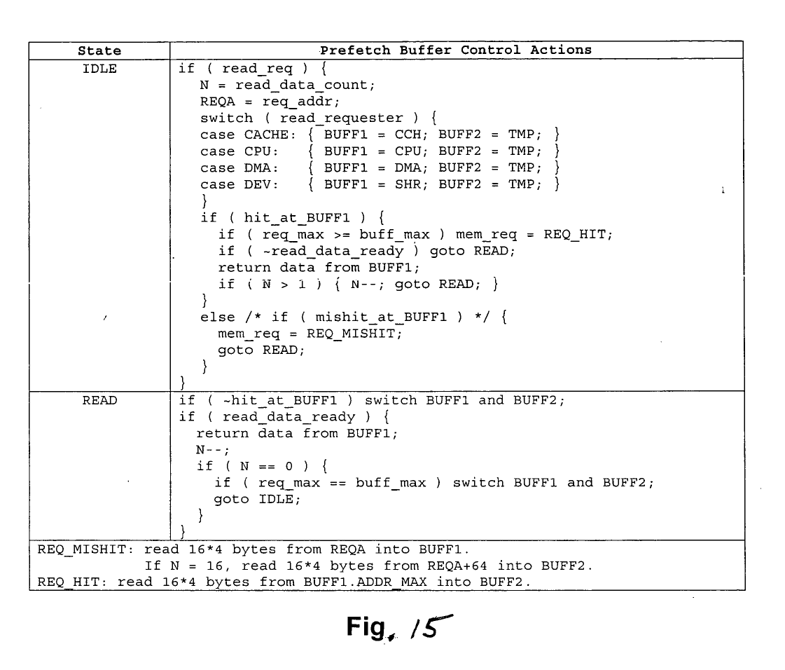

During operation, the assignments of the primary buffers BUFF1 and the secondary buffer BUFF2 for each of the requester data streams continually changes in response to the order of requests from the streams. An example of this is provided in FIG. 14.

In the example of FIG. 14, a series of read requests are made by the various requesting data streams. For each request, it is assumed, for the purpose of illustration, that the request is for data of a size that is equal to the size of the prefetch buffers, for example, carrying forward the example from above, each read request is for 64 bytes of data. In view of this, it is assumed that each read request results in a HIT, and that, since each request consumes the final byte of data in the associated primary buffer, that a prefetch to the secondary buffer (TMP) is automatically performed, and following the read operation, the assignment of the primary and secondary buffers are transposed by the buffer assignment control unit 300.

In this example, five physical prefetch buffers BUFFA, BUFFB, BUFFC, BUFFD, and BUFFE are present in the read buffers and control unit 250. In the Current State, the primary buffer for the CPU master high-performance data stream (CPU) is assigned to physical prefetch buffer BUFFA and contains prefetched data for the CPU data stream, the primary buffer for the CACHE master high-performance data stream (CCH) is assigned to physical prefetch buffer BUFFB and contains prefetched data for the CCH data stream, the primary buffer for the DMA master high-performance data stream (DMA) is assigned to physical prefetch buffer BUFFC and contains prefetched data for the DMA data stream, the primary buffer for the SHARED masters low-performance data stream (SHR) is assigned to physical prefetch buffer BUFFD and contains prefetched data for the SHR data stream, and the secondary buffer for CPU, CCH, DMA, and SHR data streams (TMP) is assigned to physical prefetch buffer BUFFE.

The first read operation in this example (Read 1) is requested by the CPU master stream. Assuming that the data requested by the read request was present in the CPU primary buffer (currently assigned to physical prefetch buffer BUFFA), and assuming that all data present in the CPU primary buffer will be consumed by the read operation, a HIT occurs, and the data are returned to the CPU. A prefetch operation is initiated for the CPU stream to load consecutive data into the secondary buffer (TMP) (currently assigned to physical prefetch buffer BUFFE). Following this, the assignments of the CPU primary buffer and TMP secondary buffer are transposed, such that the CPU primary buffer is newly assigned to physical prefetch buffer BUFFE, and the secondary buffer TMP is newly assigned to physical prefetch buffer BUFFA.

The second read operation (Read 2) is requested by the CACHE master stream. Assuming that the data requested by the read request was present in the CCH primary buffer (currently assigned to physical prefetch buffer BUFFB), and assuming that all data present in the CCH primary buffer will be consumed by the read operation, a HIT occurs, and the data are returned to the CACHE. A prefetch operation is initiated for the CCH stream to load consecutive data into the secondary buffer (TMP) (currently assigned to physical prefetch buffer BUFFA). Following this, the assignments of the CCH primary buffer and TNP secondary buffer are transposed, such that the CCH primary buffer is newly assigned to physical prefetch buffer BUFFA, and the secondary buffer TMP is newly assigned to physical prefetch buffer BUFFB.

The third read operation (Read 3) is requested by the CACHE master stream. Assuming that the data requested by the read request was present in the CCH primary buffer (currently assigned to physical prefetch buffer BUFFA), and assuming that all data present in the CCH primary buffer will be consumed by the read operation, a HIT occurs, and the data are returned to the CACHE. A prefetch operation is initiated for the CCH stream to load consecutive data into the secondary buffer (TMP) (currently assigned to physical prefetch buffer BUFFB). Following this, the assignments of the CCH primary buffer and TMP secondary buffer are transposed, such that the CCH primary buffer is newly assigned to physical prefetch buffer BUFFB, and the secondary buffer TMP is newly assigned to physical prefetch buffer BUFFA.

The fourth read operation (Read 4) is requested by the DMA master stream. Assuming that the data requested by the read request was present in the DMA primary buffer (currently assigned to physical prefetch buffer BUFFC), and assuming that all data present in the DMA primary buffer will be consumed by the read operation, a HIT occurs, and the data are returned to the DMA. A prefetch operation is initiated for the DMA stream to load consecutive data into the secondary buffer (TMP) (currently assigned to physical prefetch buffer BUFFA). Following this, the assignments of the DMA primary buffer and TMP secondary buffer are transposed, such that the DMA primary buffer is newly assigned to physical prefetch buffer BUFFA, and the secondary buffer TMP is newly assigned to physical prefetch buffer BUFFC.

The fifth read operation (Read 5) is requested by the CPU master stream. Assuming that the data requested by the read request was present in the CPU primary buffer (currently assigned to physical prefetch buffer BUFFE), and assuming that all data present in the CPU primary buffer will be consumed by the read operation, a HIT occurs, and the data are returned to the CPU. A prefetch operation is initiated for the CPU stream to load consecutive data into the secondary buffer (TMP) (currently assigned to physical prefetch buffer BUFFC). Following this, the assignments of the CPU primary buffer and TMP secondary buffer are transposed, such that the CPU primary buffer is newly assigned to physical prefetch buffer BUFFC, and the secondary buffer TMP is newly assigned to physical prefetch buffer BUFFE.

The sixth read operation (Read 6) is requested by the CPU master stream. Assuming that the data requested by the read request was present in the CPU primary buffer (currently assigned to physical prefetch buffer BUFFC), and assuming that all data present in the CPU primary buffer will be consumed by the read operation, a HIT occurs, and the data are returned to the CPU. A prefetch operation is initiated for the CPU stream to load consecutive data into the secondary buffer (TMP) (currently assigned to physical prefetch buffer BUFFE). Following this, the assignments of the CPU primary buffer and TMP secondary buffer are transposed, such that the CPU primary buffer is newly assigned to physical prefetch buffer BUFFE, and the secondary buffer TMP is newly assigned to physical prefetch buffer BUFFC.

The seventh read operation (Read 7) is requested by the CPU master stream. Assuming that the data requested by the read request was present in the CPU primary buffer (currently assigned to physical prefetch buffer BUFFE), and assuming that all data present in the CPU primary buffer will be consumed by the read operation, a HIT occurs, and the data are returned to the CPU. A prefetch operation is initiated for the CPU stream to load consecutive data into the secondary buffer (TMP) (currently assigned to physical prefetch buffer BUFFC). Following this, the assignments of the CPU primary buffer and TMP secondary buffer are transposed, such that the CPU primary buffer is newly assigned to physical prefetch buffer BUFFC, and the secondary buffer TMP is newly assigned to physical prefetch buffer BUFFE.

In this manner, the assignment of the primary and secondary buffers CPU, CCH, DMA, SHR, TMP, assigned to each data stream can vary among the physical buffers BUFFA, BUFFB, BUFFC, BUFFD, BUFFE, depending on read request traffic. Therefore, the systems and methods of the present invention allow for delivery of data available in the buffers to multiple streams, while increasing the likelihood of a HIT condition. At the same time, the system always knows which physical buffer is currently assigned to the secondary, or temporary buffer, of the streams; therefore, it is known which buffer can be safely overwritten at any given moment.

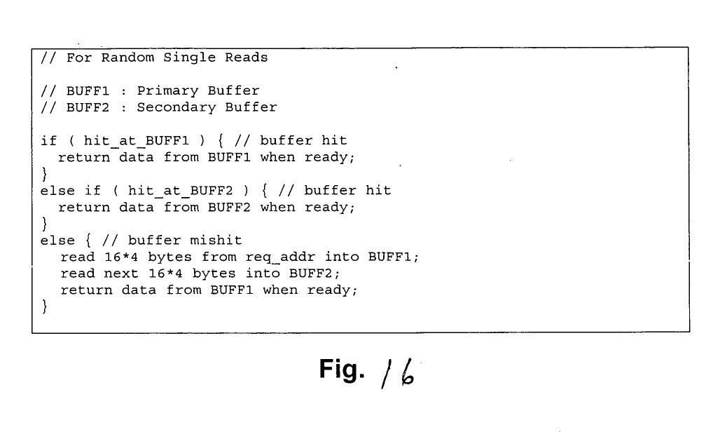

FIG. 15 is a pseudo-code representation of a finite state machine that controls prefetch operations in the read buffers and control unit 250. The finite state machine controls operations in two states: IDLE and READ. The finite state machine is placed into IDLE mode upon reset or initialization, and remains in IDLE while waiting for a read request. When the finite state machine receives a read request while in IDLE mode, the primary-secondary buffer pair for the requestor stream is determined based on the requester information.

If the hit_at_BUFF1 signal is asserted, the requested data are contained in the primary buffer of the stream, and conditional operations are performed. If the req_max value is greater than or equal to the buff_max value, then a prefetch operation is initiated and a memory request of type REQ_HIT is made to read the next consecutive 64 bytes following the buff_max address into the secondary buffer. If the requested data are not available in the primary buffer, the state is changed to READ. Otherwise, the requested data is returned to the requesting data steam from the primary buffer. If N is greater than 1, then the data count is updated, and the state is changed to READ.

If the hit_at_BUFF1 signal is not asserted, the requested data are not contained in the primary buffer of the stream and a memory request of type REQ_MISHIT is initiated to read 64 bytes beginning with the request address into the primary buffer. If N is equal to 16, a prefetch operation is performed and the subsequent 64 bytes are read into the secondary buffer, following this, the state is changed to READ.

In the READ state, if the hit_at_BUFF1 signal is not asserted, the primary and secondary buffers are switched. The requested data are returned from the primary buffer when they are available, as indicated by the read_data_ready signal being asserted. The data count is updated. When the data count becomes zero, the state is returned to IDLE. If the req_max value is equal to the buff_max value, then the primary and secondary buffers are switched prior to the state change.

Basic prefetch operations performed by the read buffers and control unit 250 for N-beat burst read requests have been described above, assuming a data element size of 4 bytes. The basic prefetch operations can be summarized as follows. Two physical prefetch buffers are paired as primary and secondary buffers to process read requests for a given data stream. The primary buffer stores the data to be consumed by the current request, while the secondary buffer stores prefetched data for future requests and is to be switched to the primary buffer. The assignments of the primary and secondary buffers are switched, or transposed, when the last data element in the primary buffer is consumed by the read request. For each read request by a stream, the primary buffer assigned to the stream is examined to determine whether a HIT or HISHIT condition occurs. On a MISHIT condition, 64 bytes of data beginning with the requested address are read from memory and stored into the primary buffer. If the current request will consume the last data element in the primary buffer, then a prefetch operation is initiated in which the following sequential 64 bytes of data are read from memory and stored into the secondary buffer. In this case, the assignments of the primary and secondary buffers are switched, or transposed. On a HIT condition, if the final data element stored in the primary buffer is consumed by the current request, then 64 bytes of data following the address of the last data element stored in the primary buffer are read from memory and stored into the secondary buffer. In this case, the assignments of the primary and secondary buffers are switched, or transposed. It should be noted that the switching of assignments of the primary and secondary buffers can take place following the read operation, or alternatively, during the read operation, depending on the system configuration.

Several variations of the basic general prefetch operation are now described, which may be useful for particular situations.

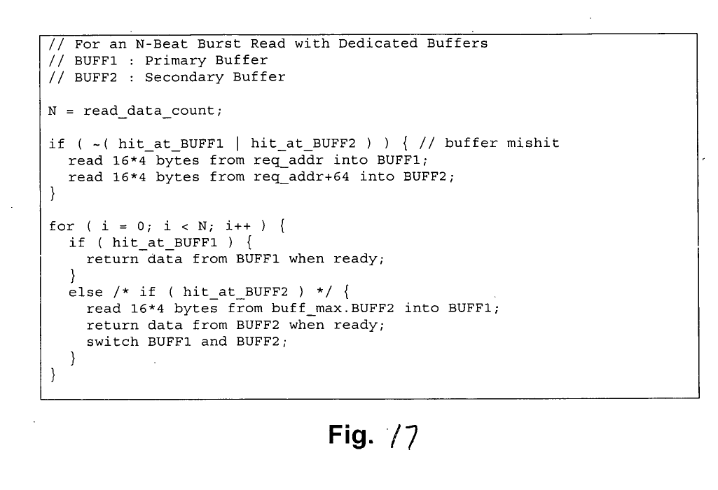

FIG. 16 is a pseudo-code representation of a special operation for random single read requests. In this example, both the primary and secondary buffers for the data stream are examined for a HIT condition, upon receiving a read request. Assuming the hit_at_BUFF1 signal is asserted, the data is returned from the primary buffer when it becomes available. If the hit_at_BUFF1 signal is not asserted and the hit_at_BUFF2 signal is asserted, then the data is returned from the secondary buffer when it becomes available. If neither the hit_at_BUFF1 signal nor the hit_at_BUFF2 signal is asserted, then 64 bytes of data beginning with the requested address are read from memory into the primary buffer, and the following 64 bytes are read from memory into the secondary buffer. The requested data is returned from the primary buffer when it becomes available. In this case, the primary and secondary buffers are used in combination as if they comprise a single buffer of 128 bytes. Intervening requests from other streams may interfere to overwrite the data prefetched into the secondary buffer; however, the primary buffer retains the first prefetched data. This operation may be desirable in the case of a sequence of non-sequential single read requests.

Instead of loading the 128 bytes beginning with the requested address into the primary and secondary buffers, the controller can alternatively store a block of 64 bytes beginning at an integral boundary address that includes the requested data into the primary buffer and the following block of 64 bytes into the secondary buffer. For example, if the requested address is 0x1030, then the controller can retrieve and store the block of 64 bytes on a 64-byte integral boundary, for example the 64 bytes beginning with address 0x1000 in this case, into the primary buffer and the following 64-byte block into the secondary buffer. This prefetch buffering scheme may be more useful in some cases.

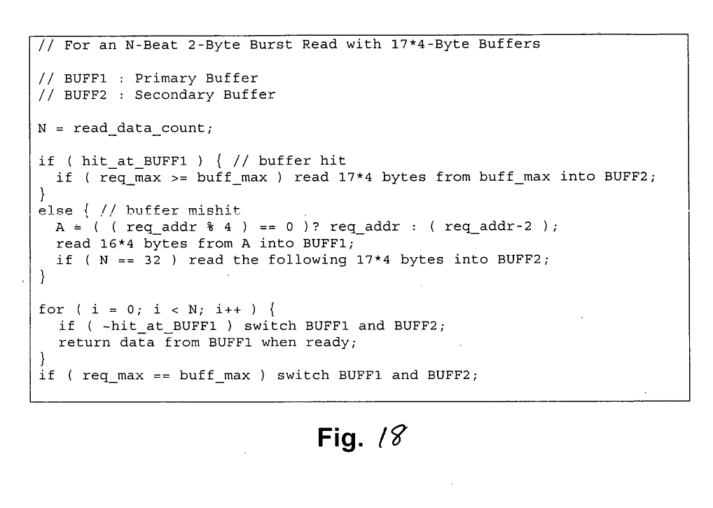

FIG. 17 is a pseudo-code representation of a special operation in response to a read request with the primary and secondary buffers dedicated to a burst stream. The request is assumed to be an N-beat burst request. If neither of the hit_at_BUFF1 signal nor the hit_at_BUFF2 signal is asserted, the 64 bytes beginning with the requested address are fetched from memory and stored into the primary buffer, and the following 64 bytes are prefetched from memory and stored into the secondary buffer. If the hit_at_BUFF1 signal is asserted, the data is returned from the primary buffer. If the hit_at_BUFF1 signal is not asserted, and the hit_at_BUFF2 signal is asserted, the data is returned to the data steam from the secondary buffer. In this case, a prefetch operation is initiated to read the 64 bytes beginning with the buff_max address of the secondary buffer, and the prefetched data in this case are stored into the primary buffer, and then the assignment of the primary and secondary buffers is switched. In this operation, as soon as the last data of the primary buffer is consumed, the prefetch operation is performed to fill the emptied primary buffer, which will be switched to secondary. This operation takes advantage of the dedicated buffers, which are not destroyed by the other streams.

A variety of operations are described above for responding to burst read requests for N 4-byte data elements. The following is a description of operations associated with responding to burst read requests for N 2-byte data, where N is less than or equal to 32. In the following description, it is assumed that prefetch operations are performed in units of 4 bytes on an integral 4-byte boundary. Note that a 4-byte data element is considered to lie on an integral 4-byte boundary if its 4 bytes are stored in byte addresses A, A+1, A+2, and A+3, where A is a multiple of 4.

A 2-byte burst request is referred to as an aligned request if its first 2-byte data is on an integral 4-byte boundary; otherwise, it is referred to as an unaligned request. The 64-byte prefetch buffers operate efficiently for aligned 2-byte burst requests in a similar manner for aligned 4-byte requests. However, operation for unaligned 2-byte burst requests is more complicated. In this case, any fetched block of 64 bytes contains the 62 bytes to be returned for a 32-beat 2-byte burst request. This is because a block of 64 bytes is fetched beginning with the location of an integral 4-byte boundary. In order to fulfill such a request, the first 62 bytes are returned from the primary buffer and the remaining 2 bytes from the secondary buffer. Since the new block of 64 bytes are requested when the current request is received, the last 2-byte segment may not be immediately available in the secondary buffer, causing a delay. This delay happens at the last beat for every 32-beat 2-byte request. In order to alleviate this problem, the buffer size can be increased to 68 bytes.

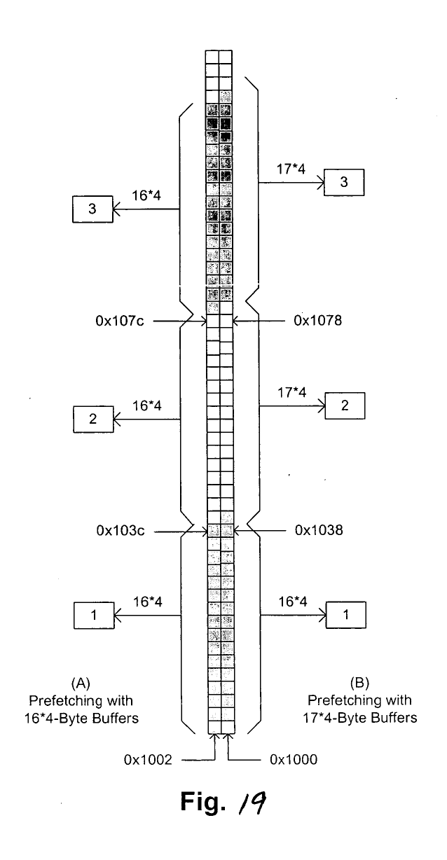

FIG. 18 is a pseudo-code representation of a special operation for responding to 32-beat 2-byte burst read requests, assuming 68-byte buffers. In this case, the prefetch buffer stores 17 4-byte data. If the hit_at_BUFF1 signal is asserted, the 68 bytes beginning with the buff_max address of the primary buffer are stored into the secondary buffer if the req_max value is greater than or equal to the buff_max value. If the hit_at_BUFF1 signal is not asserted, the 64 bytes beginning with address A are stored into the primary buffer, where A is the requested address if the requested address is a multiple of 4, otherwise A is set to requested address minus 2. If N is equal to 32, the following sequential 68 bytes are prefetched and stored into the secondary buffer. The data is returned to the data stream from the primary buffer when it is available as long as it is found in the primary buffer. If the req_max value is equal to the buff_max value, the assignment of the primary and secondary buffers are switched at the end of operation.

FIG. 19 is a diagram that illustrates three prefetch operations with 64-byte buffers and with 68-byte buffers for a sequence of unaligned 32-beat 2-byte burst requests. Three unaligned 64-byte burst requests are considered, each requesting 32 2-byte data elements from addresses 0x1002, 0x1042, and 0x1082, respectively. Assuming 64-byte buffers, the three read operations read 64 bytes from memory beginning with addresses 0x1000, 0x1040, and 0x1080, respectively.

Assuming 68-byte buffers, the first read operation reads 64 bytes beginning with address 0x1000, and the second and third read 68 bytes from 0x1042 and 0x1084, respectively. The operation of the first request is the same as that with 64-byte buffers. The second request causes no prefetch because all the requested 32 2-bytes data are stored in the primary buffer. The third request causes a prefetch of the next 68 bytes into the secondary buffer. After the first 2-byte data element is returned from the primary buffer, the assignment of the primary and secondary buffers are switched. The remaining 31 2-byte data are returned to the data stream from the new primary buffer. Since the number of prefetch operations with 68-byte buffers is smaller than that with the 64-byte buffers, the use of 68-byte buffers may greatly enhance the read performance for a long sequence of unaligned burst requests. Note that the same effect is expected for unaligned burst requests that request 64 elements of 1-byte data.

In this manner, the present invention provides a prefetch buffering solution in which a pool of prefetch buffers are organized in such a manner that there is a tight connection between the buffer pool and the data streams of interest. In this manner, efficient prefetching of data from memory is achieved in a manner that reduces the amount of required buffer space, since the secondary, or temporary buffer is shared among the dedicated data streams. In addition, the present invention provides for efficient handling of requests of different sizes.

While this invention has been particularly shown and described with references to preferred embodiments thereof, it will be understood by those skilled in the art that various changes in form and details may be made herein without departing from the spirit and scope of the invention as defined by the appended claims.

1. A memory control system for controlling the reading of data from a memory comprising:
a plurality of buffers that buffer data read from the memory; and
a buffer assignment unit that assigns a plurality of data streams to the plurality of buffers,
wherein the buffer assignment unit assigns to each data stream a primary buffer and a secondary buffer of the plurality of buffers, such that upon receiving a data request from a first data stream, the primary buffer assigned to the first data stream contains fetch data of the data request and the secondary buffer assigned to the first data stream contains prefetch data for a subsequent data request.

2. The memory control system of claim 1 wherein the buffer assignment unit, following completion of a data transfer from the primary buffer, reassigns the secondary buffer of the first data stream as the primary buffer of the first data stream.

3. The memory control system of claim 2 wherein the buffer assignment unit, following completion of the data transfer from the primary buffer, further reassigns the primary buffer of the first data stream as the secondary buffer of the first data stream.

4. The memory control system of claim 1 wherein, when the fetch data of the primary buffer has been read, the buffer assignment unit reassigns the primary buffer and secondary buffer such that the secondary buffer containing the fetch data is reassigned as the primary buffer and such that the primary buffer contains new prefetch data.

5. The memory control system of claim 1 wherein the buffer assignment unit assigns the secondary buffer to the plurality of the data streams.

6. The control system of claim 2 wherein upon receiving a data request from a second data stream, the primary buffer assigned to the second data stream contains fetch data of the data request and the secondary buffer assigned to the second data stream contains prefetch data for a subsequent data request from the second data stream.

7. The memory control system of claim 6 wherein the secondary buffer assigned to the second data stream and the secondary buffer assigned to the first data stream are the same buffer of the plurality of buffers.

8. The memory control system of claim 6 wherein the buffer assignment unit, following completion of a data transfer from the primary buffer assigned to the second data stream, reassigns the secondary buffer of the second data stream as the primary buffer of the second data stream.

9. The memory control system of claim 8 wherein the buffer assignment unit, following completion of the data transfer from the primary buffer assigned to the second data stream, further reassigns the primary buffer of the second data stream as the secondary buffer of the second data stream.

10. The memory control system of claim 6 wherein, when the fetch data of the primary buffer assigned to the second data stream has been read, the buffer assignment unit reassigns the primary buffer assigned to the second data stream and the secondary buffer assigned to the second data stream such that the secondary buffer containing the fetch data is reassigned as the primary buffer and such that the primary buffer contains new prefetch data.

11. The memory control system of claim 1 wherein at least one of the plurality of data streams comprises a high-performance data stream and wherein the buffer assignment unit assigns at least one of the plurality of buffers to the high-performance data stream to allow for continuous access to at least one of the buffers by a requestor unit of the high-performance data stream.

12. The memory control system of claim 11 wherein the high-performance data stream comprises a data stream that is requested by at least one of the following types of requester units: microprocessor, cache, and direct memory access (DMA).

13. The memory control system of claim 11 wherein a plurality of the data streams comprise low-performance data streams and wherein the buffer assignment unit manages access to one of the plurality of buffers among the low-performance requester streams.

14. The memory control system of claim 13 wherein the low-performance data stream comprises a data stream that is requested by at least one of the following types of requestor units: video output, audio output, network output, and co-processor output.

15. The memory control system of claim 1 wherein the memory comprises a memory that is external to the memory control system.

16. A memory control system for controlling the reading of data from a memory comprising:
a plurality of read buffers that buffer data read from the memory in response to read requests from a plurality of data streams; and
a buffer assignment unit that assigns to each of the plurality of data streams a primary buffer of the plurality of read buffers; the buffer assignment unit assigning a secondary buffer of the plurality of read buffers to the plurality of data steams, such that each of the plurality of data streams is assigned a unique primary buffer and such that the secondary buffer is shared among the plurality of data streams.

17. The memory control system of claim 16 wherein, when a read request is received from a data stream, and the requested data is contained in the primary buffer assigned to the data stream, the requested data is transferred from the primary buffer to the data stream, and, if a last data element of the primary buffer is to be read as a result of the request, a prefetch operation is initiated to transfer data from the memory to the secondary buffer.

18. The memory control system of claim 17 wherein the assignments of the primary buffer and the secondary buffer are transposed as a result of the prefetch operation.

19. The memory control system of claim 16 wherein at least one of the plurality of data streams comprises a high-performance data stream and wherein the buffer assignment unit assigns at least one of the plurality of buffers to the high-performance data stream to allow for continuous access to at least one of the buffers by a requestor unit of the high-performance data stream.

20. The memory control system of claim 19 wherein the high-performance data stream comprises a data stream that is requested by at least one of the following types of requester units: microprocessor, cache, and direct memory access (DMA).

21. The memory control system of claim 16 wherein a plurality of the data streams comprise low-performance data streams and wherein the buffer assignment unit manages access to one of the plurality of buffers among the low-performance requestor streams.

22. The memory control system of claim 21 wherein the low-performance data stream comprises a data stream that is requested by at least one of the following types of requestor units: video output, audio output, network output, and co-processor output.

23. The memory control system of claim 16 wherein the memory comprises a memory that is external to the memory control system.

24. The memory control system of claim 16 further comprising a memory interface unit for managing signal exchange between the memory control system and the memory during a memory read operation.

25. The memory control system of claim 16 further comprising a system bus control unit for managing signal exchange between the memory control system and a system bus on which the read requests are received for the plurality of data streams.

26. The memory control system of claim 16 wherein the read buffers each include a buffer tag that receives a read address from the read request and determines whether a HIT or MISHIT condition occurs in the read buffer and determines whether the requested data is ready for transfer to the data stream.

27. The memory control system of claim 16 wherein the read buffers each include a register array for storing buffered data, a write pointer that stores the location of the register array available for the next write operation, and a read pointer that stores the location of the register array available for the next read operation.

28. The memory control system of claim 16 wherein, when a read request is received from a data stream, the primary buffer and the secondary buffer assigned to the data stream are inspected to determine whether the requested data is available in either the primary buffer or the secondary buffer.

29. The memory control system of claim 16 wherein the read buffers are of a size that is one data element greater than a standard data block size.

30. The memory control system of claim 29 wherein the read buffers are 68 bytes in size, and wherein the standard data block size is 64 bytes.

31. A method for controlling the reading of data from a memory comprising:
assigning a plurality of data streams to a plurality of buffers that buffer data read from the memory, and
assigning to each data stream a primary buffer and a secondary buffer of the plurality of buffers, such that upon receiving a data request from a first data stream, the primary buffer assigned to the first data stream contains fetch data of the data request and the secondary buffer assigned to the first data stream contains prefetch data for a subsequent data request.

32. The method of claim 31 further comprising, following completion of a data transfer from the primary buffer, reassigning the secondary buffer of the first data stream as the primary buffer of the first data stream.

33. The method of claim 32 further comprising, following completion of the data transfer from the primary buffer, further reassigning the primary buffer of the first data stream as the secondary buffer of the first data stream.

34. The method of claim 31 further comprising, when the fetch data of the primary buffer has been read, reassigning the primary buffer and secondary buffer such that the secondary buffer containing the fetch data is reassigned as the primary buffer and such that the primary buffer contains new prefetch data.

35. The method of claim 31 further comprising assigning the secondary buffer to the plurality of the data streams.

36. The method of claim 32 further comprising, upon receiving a data request from a second data stream, the primary buffer assigned to the second data stream contains fetch data of the data request and the secondary buffer assigned to the second data stream contains prefetch data for a subsequent data request from the second data stream.

37. The method of claim 36 wherein the secondary buffer assigned to the second data stream and the secondary buffer assigned to the first data stream are the same buffer of the plurality of buffers.

38. The method of claim 36 further comprising, following completion of a data transfer from the primary buffer assigned to the second data stream, reassigning the secondary buffer of the second data stream as the primary buffer of the second data stream.

39. The method of claim 38 further comprising, following completion of the data transfer from the primary buffer assigned to the second data stream, reassigning the primary buffer of the second data stream as the secondary buffer of the second data stream.

40. The method of claim 36 further comprising, when the fetch data of the primary buffer assigned to the second data stream has been read, reassigning the primary buffer assigned to the second data stream and the secondary buffer assigned to the second data stream such that the secondary buffer containing the fetch data is reassigned as the primary buffer and such that the primary buffer contains new prefetch data.

41. The method of claim 31 wherein at least one of the plurality of data streams comprises a high-performance data stream and further comprising assigning at least one of the plurality of buffers to the high-performance data stream to allow for continuous access to at least one of the buffers by a requestor unit of the high-performance data stream.

42. The method of claim 41 wherein the high-performance data stream comprises a data stream that is requested by at least one of the following types of requestor units: microprocessor, cache, and direct memory access (DMA).

43. The method of claim 41 wherein a plurality of the data streams comprise low-performance data streams and further comprising managing access to one of the plurality of buffers among the low-performance requestor streams.

44. The method of claim 43 wherein the low-performance data stream comprises a data stream that is requested by at least one of the following types of requestor units: video output, audio output, network output, and co-processor output.

45. The method of claim 31 wherein the memory comprises a memory that is external to the memory control system.

46. A method for controlling the reading of data from a memory comprising:
buffering data read from the memory at a plurality of read buffers in response to read requests from a plurality of data streams;
assigning to each of the plurality of data streams a primary buffer of the plurality of read buffers; and
assigning a secondary buffer of the plurality of read buffers to the plurality of data steams, such that each of the plurality of data streams is assigned a unique primary buffer and such that the secondary buffer is shared among the plurality of data streams.

47. The method of claim 46 further comprising, when a read request is received from a data stream, and the requested data is contained in the primary buffer assigned to the data stream, transferring the requested data from the primary buffer to the data stream, and, if a last data element of the primary buffer is to be read as a result of the request, initiating a prefetch operation to transfer data from the memory to the secondary buffer.

48. The method of claim 47 further comprising transposing the assignments of the primary buffer and the secondary buffer as a result of the prefetch operation.

49. The method of claim 46 wherein at least one of the plurality of data streams comprises a high-performance data stream and further comprising assigning at least one of the plurality of buffers to the high-performance data stream to allow for continuous access to at least one of the buffers by a requestor unit of the high-performance data stream.

50. The method of claim 49 wherein the high-performance data stream comprises a data stream that is requested by at least one of the following types of requestor units: microprocessor, cache, and direct memory access (DMA).

51. The method of claim 46 wherein a plurality of the data streams comprise low-performance data streams and further comprising managing access to one of the plurality of buffers among the low-performance requestor streams.

52. The method of claim 51 wherein the low-performance data stream comprises a data stream that is requested by at least one of the following types of requestor units: video output, audio output, network output, and co-processor output.

53. The method of claim 46 wherein the memory comprises a memory that is external to the memory control system.

54. The method of claim 46 further comprising managing signal exchange between the memory control system and the memory during a memory read operation.

55. The method of claim 46 further comprising managing signal exchange between the memory control system and a system bus on which the read requests are received for the plurality of data streams.

56. The method of claim 46 wherein the read buffers each include a buffer tag that receives a read address from the read request and determines whether a HIT or MISHIT condition occurs in the read buffer and determines whether the requested data is ready for transfer to the data stream.

57. The method of claim 46 wherein the read buffers each include a register array for storing buffered data, a write pointer that stores the location of the register array available for the next write operation, and a read pointer that stores the location of the register array available for the next read operation.

58. The method of claim 46 further comprising, when a read request is received from a data stream, inspecting the primary buffer and the secondary buffer assigned to the data stream to determine whether the requested data is available in either the primary buffer or the secondary buffer.

59. The method of claim 46 wherein the read buffers are of a size that is one data element greater than a standard data block size.

60. The method of claim 59 wherein the read buffers are 68 bytes in size, and wherein the standard data block size is 64 bytes.
